(19) United States
(12) Patent Application Publication
(10) Pub. No.: US 2011/0108693 A1
(43) Pub. Date: May 12, 2011

(54) Lantern holder and method for using same

(75) Inventors: Lyle Thomas, Drumheller (CA); Shelley Thomas, Drumheller, CA (US)

(73) Assignee: Lyle Thomas Consulting Ltd., Drumheller (CA)

(21) Appl. No.: 12/591,145

(22) Filed: Nov. 10, 2009

(51) Int. Cl. F16M 13/02; F16M 13/00

(52) U.S. Cl. 248/225.21; 248/298.1

(57) ABSTRACT

Described herein are a lantern holder for affixing a lantern to a supporting member such as a rail or fence and a method for using same. The lantern holder includes a mounting portion that is shaped to mount on to the supporting member; first and second bracing portions each extending from the mounting portion and shaped to contact the sides of the supporting member to help brace the mounting portion; and a lantern retainer that is configured to retain the lantern. The mounting portion can be composed of first and second adjustable pieces that are movable relative to each other such that the mounting portion can be mounted on to supporting members of different depths.

### TECHNICAL FIELD

The present application relates to a lantern holder. More particularly, the present application relates to a lantern holder for affixing a lantern to a supporting member such as a rail or fence.

### BACKGROUND

Lanterns are a commonly used illumination device. When used for illumination, lanterns are often placed directly on the ground. For example, lanterns can be placed at various positions on a lawn, thus illuminating the lawn so that the lawn can be enjoyably and safely walked on at night.

However, problems exist with placing lanterns directly on the ground. For example, the lanterns can act as an obstacle when performing activities such as shovelling snow or mowing grass. Not only can this prolong the length of time a person requires to perform these activities, but the lanterns may suffer damage as a result. Additionally, a person may have no ground or floor space on which to place a lantern. For example, a person who lives in an apartment may have only a small balcony but may nonetheless want to use a lantern for decorative or illumination purposes. Being forced to place a lantern on the floor of the balcony may be an unsatisfactory solution.

Consequently, there exists a need for an apparatus that can be used to ameliorate at least one of the above mentioned problems.

### SUMMARY

According to a first aspect, there is provided a lantern holder for affixing a lantern to a supporting member. The lantern holder includes a mounting portion shaped to mount on to the supporting member and comprising first and second adjustable pieces movable relative to each other such that the mounting portion can be mounted on to supporting members of different depths; first and second bracing portions each extending from the mounting portion, the first bracing portion shaped to contact a first side of the supporting member and the second bracing portion shaped to contact an opposing second side of the supporting member, the first and second bracing portions thereby helping to brace the mounting portion on the supporting member; and a lantern retainer configured to retain the lantern and mounted to the mounting portion or one of the first and second bracing portions.

The first and second bracing portions can respectively extend adjacent to the first and second sides of the supporting member. Additionally, the first and second adjustable pieces can be slidable relative to each other. The second adjustable piece can have a hollow interior shaped to receive the first adjustable piece therein.

The first adjustable piece can have a button movable between recessed and protruded positions thereon, and the second adjustable piece can have an aperture that is shaped and positioned to receive the button when it is in the protruded position and when the first adjustable piece is in the hollow interior. The first adjustable piece is anchored to the second adjustable piece when the first adjustable piece is in the hollow interior and the button is in the aperture.

The first adjustable piece can also include a cavity and a spring disposed within the cavity that is movable between biased and unbiased positions. The button can be coupled to one end of the spring and be in the recessed position when the spring is in the biased position and can be in the protruded position when the spring is in the unbiased position.

The button may have a chamfered edge to facilitate insertion of the first adjustable piece into the hollow interior of the second adjustable piece.

The first bracing portion may have a lantern supporting portion extending therefrom such that the lantern supporting portion is not parallel to the first side of the supporting member, and the lantern retainer can be mounted on to the lantern supporting portion. The lantern supporting portion can be perpendicular to the first side of the supporting member.

The second bracing portion can have an additional lantern supporting portion extending therefrom such that the additional lantern supporting portion is not parallel to the second side of the supporting member. An additional lantern retainer may be mounted on to the additional lantern supporting portion. The additional lantern supporting portion can be perpendicular to the second side of the supporting member.

According to another aspect, there is provided a lantern holder for affixing a lantern to a rail or fence. The lantern holder has a mounting portion shaped to mount to a top surface of the rail or fence and comprising first and second adjustable pieces slidable relative to each other such that the mounting portion can be mounted on to rails or fences of different depths; first and second bracing portions each extending downwards from the mounting portion, the first bracing portion shaped to contact a first side of the rail or fence and the second bracing portion extending adjacent to an opposing second side of the rail or fence, the first and second bracing portions thereby helping to brace the mounting portion on the rail or fence; and a lantern retainer configured to retain the lantern and mounted to a top surface of the mounting portion or one of the first and second bracing portions.

The first and second bracing portions can respectively extend adjacent to the first and second sides of the rail or fence. The second adjustable piece can have a hollow interior shaped to receive the first adjustable piece therein.

The first adjustable piece can have a button movable between recessed and protruded positions on the first adjustable piece and the second adjustable piece can have an aperture shaped and positioned to receive the button when it is in the protruded position and when the first adjustable piece is in the hollow interior. The first adjustable piece is anchored to the second adjustable piece when the first adjustable piece is in the hollow interior and the button is in the aperture.

The first adjustable piece can also have a cavity and a spring disposed within the cavity that is movable between biased and unbiased positions. The button can be coupled to one end of the spring and be in the recessed position when the spring is in the biased position and be in the protruded position when the spring is in the unbiased position. The button may have a chamfered edge to facilitate insertion of the first adjustable piece into the hollow interior of the second adjustable piece.

According to another aspect, there is provided a method for affixing a lantern to a rail or fence. The method includes sliding a lantern holder on to the rail or fence and placing a lantern into the lantern retainer. The lantern holder includes a mounting portion shaped to mount to a top surface of the rail or fence; first and second bracing portions each extending downwards from the mounting portion, the first bracing portion shaped to contact a first side of the rail or fence and the second bracing portion extending adjacent to an opposing second side of the rail or fence, the first and second bracing portions thereby helping to brace the mounting portion on the rail or fence; and a lantern retainer configured to retain the lantern and mounted to a top surface of the mounting portion or one of the first and second bracing portions.

The first and second bracing portions of the lantern holder can respectively extend adjacent to the first and second sides of the rail or fence.

The mounting portion can have first and second adjustable pieces movable relative to each other such that the mounting portion can be mounted on to rails or fences of different depths.

Beneficially, the above aspects allow the lantern to be affixed to a supporting member such as a rail or fence without using nails or screws, which could damage the supporting member. The above aspects also allow the lantern to be supported in an elevated position, which prevents the lantern from acting as a ground obstacle and which is beneficial when ground surface area is at a premium, such as on a small balcony. Additionally, some of the above aspects incorporate an adjustable mounting portion, which allows any given lantern holder to be flexibly used with supporting members of various depths.

### BRIEF DESCRIPTION OF THE DRAWINGS

In the accompanying drawings, which illustrate one or more exemplary embodiments:

FIG. 1 is a perspective view of a lantern holder according to a first embodiment;

FIG. 2 is a perspective view of the lantern holder according to a second embodiment;

FIG. 3 is a side sectional view of a mounting portion used in the lantern holder according to the second embodiment, the mounting portion having first and second adjustable pieces that are slidable relative to each other;

FIG. 4 is a perspective view of the lantern holder according to a third embodiment;

FIG. 5 is a perspective view of the lantern holder according to a fourth embodiment;

FIG. 6(a) is a side elevation view of a mounting portion that includes an assembly for anchoring the first adjustable piece to the second adjustable piece, according to a fifth embodiment; and

FIG. 6(b) is a sectional view taken along line 6b-6b of FIG. 6(a).

### DETAILED DESCRIPTION

Directional terms such as “top”, “bottom”, “left”, “right”, “horizontal”, “vertical”, “transverse” and “longitudinal” are used in this description merely to assist the reader to understand the described embodiments and are not to be construed to limit the orientation of any described method, product, apparatus or parts thereof, whether in operation or in connection to another object.

In order to ameliorate problems associated with placing a lantern directly on the ground or other surface that it is illuminating (e.g.: directly on the grass in the case of a lantern used to illuminate a lawn), the lantern can be elevated. When elevated, the lantern continues to provide illumination but ceases to be an obstacle for persons performing activities such as snow shovelling or grass mowing, and also ceases to monopolize any surface area, which can be particularly useful when the lantern is used to illuminate a relatively confined location such as a small balcony or patio.

The embodiments described herein describe a lantern holder 10 that can be used to elevate a lantern 12 by affixing it on to a supporting member such as a rail 14 or a fence 15. The point at which the lantern 12 is affixed to the rail 14 or fence 15 is selected such that affixing the lantern 12 will be less obtrusive than placing the lantern 12 on the ground. One particularly suitable and popular type of lantern 12 for use with the lantern holder 10 is a wireless lantern; i.e., a lantern that is not powered using a wired electrical connection. Wireless lanterns include lanterns powered using batteries, fuel (e.g.: propane), or solar power.

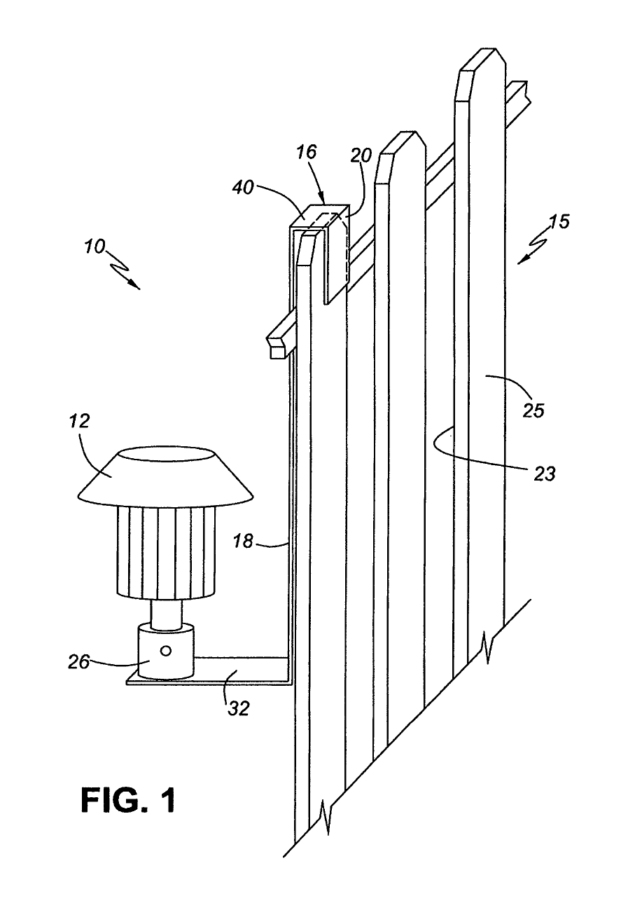

Referring now to FIG. 1, there is shown the lantern holder 10 according to a first embodiment mounted on to a top surface 42 of the fence 15. The lantern holder 10 is composed of a mounting portion 16 having a top surface 40 and an opposing bottom surface; the bottom surface of the mounting portion 16 contacts the top surface 42 of the fence 15. In the depicted embodiment, the fence 15 is a picket fence; in alternative embodiments (not shown), the fence 15 may be, for example, a chain link fence topped with a rail on to which the lantern holder 10 can rest. Extending downwards from either side of the mounting portion 16 are first and second bracing portions 18, 20, and extending downwards from either side of the top surface 42 of the fence 15 are opposing first and second sides 23, of the fence 15. The first bracing portion 18 extends adjacent to (i.e.: is flush against) and contacts the first side 23 of the fence 15, while the second bracing portion 20 extends adjacent to and contacts the opposing second side 25 of the fence 15. The width of the mounting portion 16 is selected such that both the first and second bracing portions 18, 20 frictionally engage the sides 23, 25 of the fence 15, thereby helping to brace and stabilize the mounting portion 16 on to the top surface 42 of the fence 15. In alternative embodiments (not depicted), even if the first and second bracing portions 18, 20 do not extend adjacent to the sides 23, 25 of the fence 15, so long as the first bracing portion 18 presses against one point on the first side 23 of the fence 15 and the second bracing portion 20 presses against another point on the second side 25 of the fence 15, the first and second bracing portions 18, 20 can act as a clamp, thereby helping to brace and stabilize the mounting portion 16 on to the top surface 42 of the fence 15.

In FIG. 1, the first bracing portion 18 extends down a substantial portion of the first side 23 of the fence 15 and includes a lantern supporting portion 32 that extends from one end of the first bracing portion 18 perpendicularly from the first side 23 of the fence 15. Mounted on to the lantern supporting portion 32 is a lantern retainer 26, which is used to releasably retain the lantern 12. The lantern retainer 26 can be any suitable lantern retainer as is known to a skilled person; for example, the lantern retainer 26 depicted in FIG. 1 has three screws that are screwed in a direction perpendicular to the longitudinal axis of the lantern 12. When screwed sufficiently away from the longitudinal axis, the lantern 12 can be removed from or inserted into the lantern retainer 26; when screwed towards the longitudinal axis and the lantern 12 is resting in the lantern retainer 26, the lantern 12 is secured to the lantern retainer 26.

While the dimensions of the lantern holder 10 will vary with the size of the fence 15 on which the lantern holder 10 is placed, the dimensions of an exemplary lantern holder 10 follow. By “length”, it is meant the direction from the bottom to the top of the fence 15; by “width”, it is meant the direction perpendicular to the length and parallel to the surface of the sides 23, 25 of the fence 15; and by “depth”, it is meant the direction perpendicular to both the length and width and that is normal to the surface of the sides 23, 25 of the fence 15.

| | | |
|---|---|---|
| Length of the first bracing portion 18 | 12 | inches |
| Length of the second bracing portion | 2¼ | inches |
| 20 | | |
| Width of the first and second bracing | 1¼ | inches |
| portions 18, 20 | | |
| Depth (thickness) of the first and | ¼ | inch |
| second bracing portions 18, 20 | | |
| Depth of the top side 40 of the | 1⅜ | inches |
| mounting portion 16 | | |
| Depth of the bottom side of the | ⅞ | inch |
| mounting portion 16 (i.e.: the distance | | |
| between the surfaces of the bracing | | |
| portions 18, 20 that contact the sides | | |
| 23, 25 of the fence 15) | | |
| Depth of the lantern supporting | 4 | inches |
| portion 32 | | |
| Length of the lantern retainer 26 | 1½ | inches |
| Depth of the lantern retainer 26 | 1¼ | inches |
| Thickness of the walls of the lantern | ⅛ | inch |
| retainer 26 | | |

The lantern holder 10 can be made of any suitable materials. For example, wood, plastic, and metal (e.g.: aluminum) can all be used for fabrication.

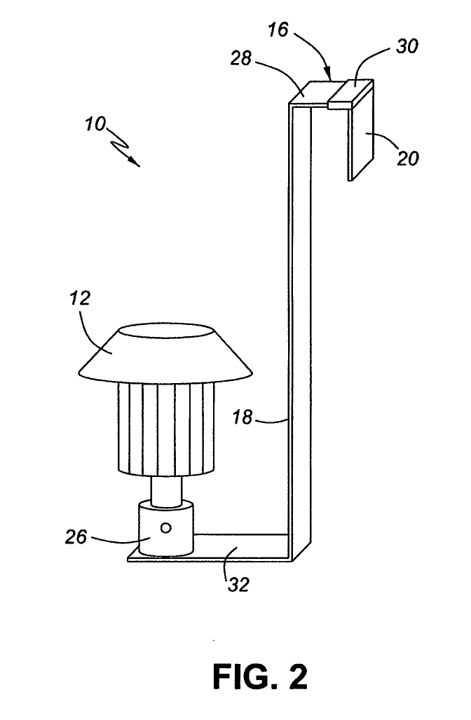

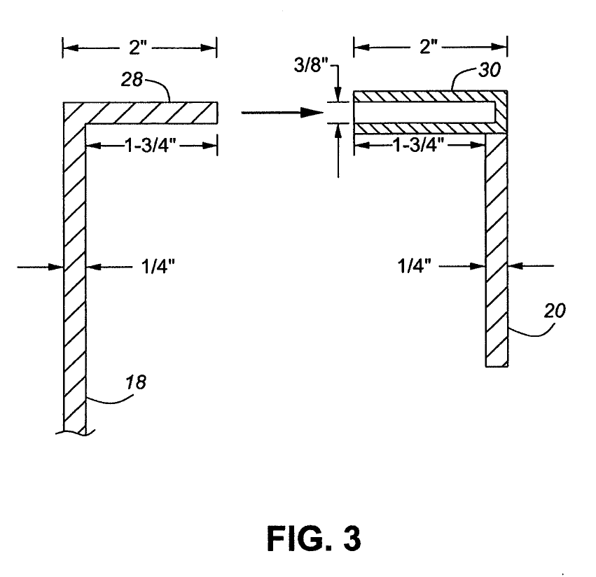

Referring now to FIGS. 2 and 3, there is depicted the lantern holder 10 according to a second embodiment. The lantern holder 10 depicted in FIG. 2 is identical to the lantern holder depicted in FIG. 1 with the exception that the mounting portion 16 is composed of first and second adjustable pieces 28, 30 that are movable relative to each other such that the mounting portion can be mounted on to fences 15 of varying depths. The second adjustable piece 30 has a hollow interior into which the first adjustable piece 28 can be slidably inserted. The adjustable pieces 28, 30 are sized such that the second adjustable piece 30 frictionally retains the first adjustable piece 28, thereby allowing the lantern holder 10 to be securely and variably sized to fit differently sized fences 15.

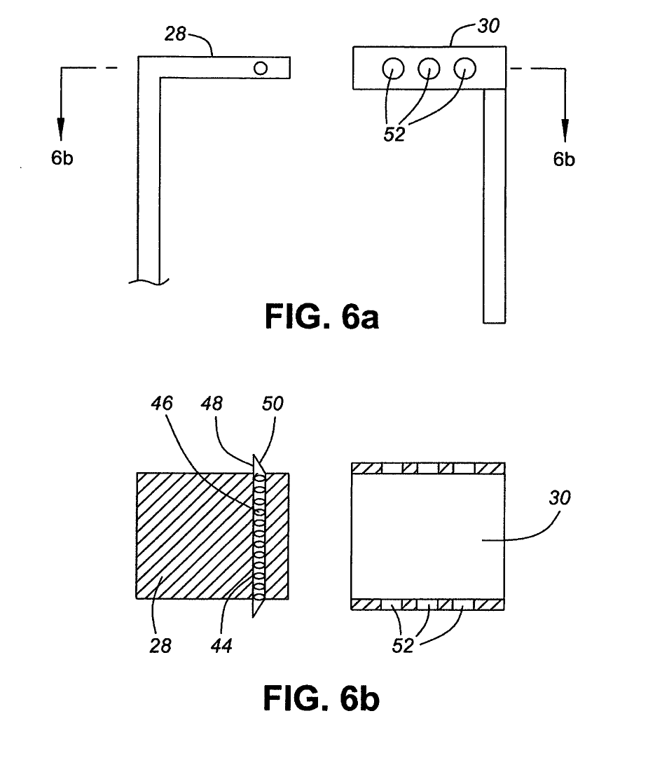

As can be seen in FIG. 3, the first and second adjustable pieces 28, 30 are rectangular in shape. The second adjustable piece 30 has four sides that frictionally engage and retain the first adjustable piece 28 when the first adjustable piece 28 is inserted into the second adjustable piece 30. In an alternative embodiment (not shown), the second adjustable piece 30 has only three sides in that the bottom side of the second adjustable piece 30 that would otherwise contact the top of the fence 15 is missing, which allows the bottom of the first adjustable piece 28 to directly contact the top surface 42 of the fence 15. In further alternative embodiments, instead of the second adjustable piece 30 receiving and frictionally retaining the first adjustable piece 28 in its hollow interior, other means for adjustably coupling the first and second adjustable pieces 28, 30 can be used. For example, the first and second adjustable pieces 28, 30 can each have a series of aligned holes through which a rod can be inserted to securely couple the pieces 28, 30 together (not shown). Alternatively, the means for adjustably coupling can be an assembly for anchoring the first adjustable piece 28 to the second adjustable piece 30 as depicted in FIGS. 6(a) and 6(b) and as discussed in more detail, below.

Aside from the dimensions of the first and second adjustable pieces 28, 30, the dimensions of the lantern holder 10 according to the second embodiment are identical to those of the first embodiment. Exemplary dimensions of the first and second adjustable pieces 28, 30 that can fit a fence having a depth of 3 inches are indicated in FIG. 3.

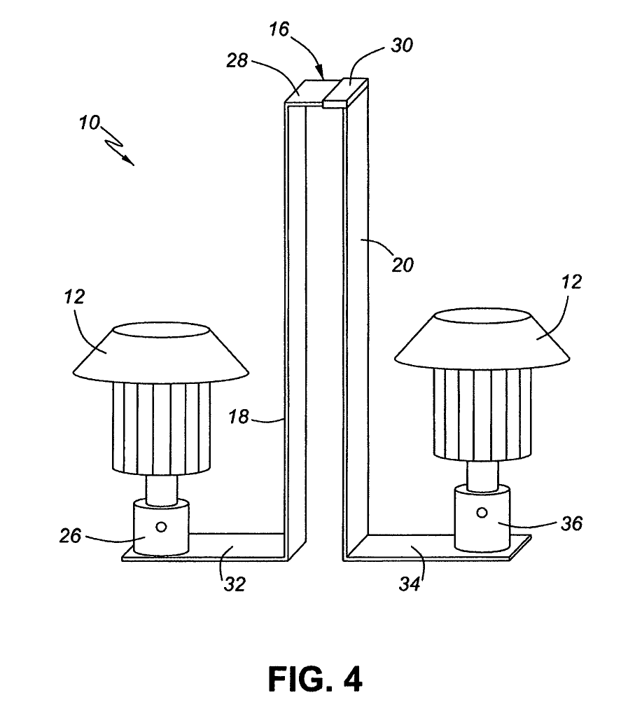

Referring now to FIG. 4, there is depicted a third embodiment of the lantern holder 10. The third embodiment of the lantern holder 10 is identical to the second embodiment of the lantern holder 10 with the exception that the second bracing portion 20 extends down a substantial portion of the second side 25 of the fence 15 and includes an additional lantern supporting portion 34 that extends from one end of the second bracing portion 20 perpendicularly from the second side 25 of the fence 15. Mounted on to the additional lantern supporting portion 34 is an additional lantern retainer 36, which is used to releasably retain a second lantern 12. The additional lantern retainer 36 and the additional lantern supporting portion 34 are identical to the lantern retainer 26 and the lantern supporting portion 32, respectively.

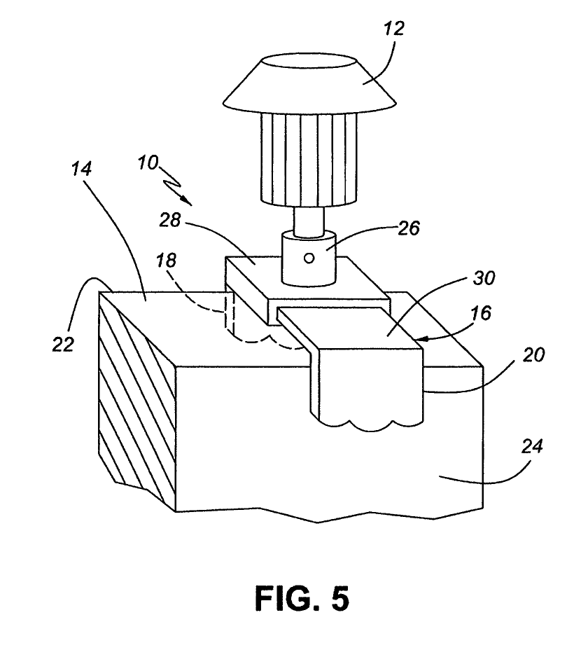

Referring now to FIG. 5, there is depicted a fourth embodiment of the lantern holder 10 that can be mounted on to the rail 14. The first bracing portion 18 of the fourth embodiment of the lantern holder 10 extends down a first side 22 of the rail 14, while the second bracing portion 20 extends down a second side 24 of the rail 14. In the depicted embodiment, both the first and second bracing portions 18, 20 have lengths of 2½ inches and widths of 3 inches and do not have lantern supporting portions extending from the bottom ends thereof; otherwise, the dimensions and construction of the fourth embodiment and the third embodiment are identical. Consequently, the mounting portion 16 of the fourth embodiment of the lantern holder 10 is adjustable to fit rails of different depths. In contrast to the aforedescribed embodiments of the lantern holder 10, in the fourth embodiment the lantern retainer 26 is mounted directly on to the top surface 40 of the mounting portion 16. The rail 14 may be, for example, a rail that extends along the perimeter of a balcony, porch, terrace, or fence.

Referring now to FIGS. 6(a) and 6(b), there is depicted the mounting portion 16 according to a fifth embodiment of the lantern holder 10. The mounting portion 16 depicted in FIGS. 6(a) and 6(b) has a pair of buttons 48 that are movable between recessed and protruded positions on the first adjustable piece 28. When the buttons 48 are partially or entirely contained within the first adjustable piece 28 they are in the recessed position, and when the buttons 48 are protruding from the first adjustable piece 28 as far as possible they are in the protruded position. Disposed within the first adjustable piece 28 is a cavity 44 containing a spring 46. Each end of the spring 46 is affixed to one of the buttons 48; when the buttons 48 are in the recessed position, the spring 46 is in a biased position and when the buttons 48 are in the protruded position (as they are in FIG. 6(b)) the spring 46 is in an unbiased position. Notably, “unbiased” does not necessarily mean that the spring 46 is completely uncompressed; instead, it includes states in which the spring 46 is simply relatively uncompressed relative to when it is in the biased position.

The second adjustable piece 30 has a series of apertures 52 that are shaped and positioned to receive the buttons 48 as the first adjustable piece 28 is inserted into the hollow interior of the second adjustable piece 30. For example, the cross-sectional area of the apertures 52 is slightly larger than the cross-sectional area of the buttons 48 so that the buttons 48 can fit snugly through the apertures 52. Additionally, the apertures 52 are aligned such that as the first adjustable piece 28 is inserted deeper into the second adjustable piece 30, the buttons 48 are insertable into each pair of opposing apertures 52 in turn. When the first adjustable piece 28 is moving through the second adjustable piece 30, the buttons 48 are in their recessed position; when the first adjustable piece 28 is positioned such that the buttons 48 are aligned with any opposing pair of apertures 52, the spring 46 pushes the buttons 48 at least partially through the apertures and into their protruded position, thereby anchoring the first adjustable piece 28 to the second adjustable piece 30. Such functionality is beneficial in that the first and second adjustable pieces 28, 30 will remain in a fixed position and will not slide off the fence 15 or rail 14 unless a person releases the first and second adjustable pieces 28, 30 from each other. In order to release the pieces 28, 30, a person can push on the buttons 48 through the apertures 52 such that the buttons 48 are biased in the recessed position, and then slide the first adjustable piece 28 further into or out of the second adjustable piece 30. As is evident in FIG. 6(b), the buttons 48 are chamfered to facilitate insertion of the first adjustable piece 28 into the second adjustable piece 30.

Beneficially, all of the above embodiments can be coupled to the fence 15 or rail 14 without the use of nails or screws, thereby allowing the lantern holder 10 to be attached to and removed from the fence 15 or rail 14 quickly, without the use of tools, and without marring or in any way damaging the fence 15 or rail 14. In particular, any of the above embodiments of the lantern holder 10 can be used to affix the lantern 12 to the supporting member by sliding the mounting portion 16 over the top surface of the supporting member and by then placing the lantern 12 into one of the lantern retainers 26, 36. In embodiments in which the depth of the mounting portion 16 of the lantern holder 10 is adjustable, to facilitate ease of mounting the mounting portion 16 can first be loosely placed on to the supporting member, and subsequently the depth of the mounting portion 16 can be adjusted to snugly and securely fit the mounting portion 16 to the supporting member.

While one or more particular embodiments have been described in the foregoing, it is to be understood that other embodiments are possible and are intended to be included herein. It will be clear to any person skilled in the art that modifications of and adjustments to these embodiments, not shown, are possible.

1. A lantern holder for affixing a lantern to a supporting member, the lantern holder comprising:
(a) a mounting portion shaped to mount on to the supporting member and comprising first and second adjustable pieces movable relative to each other such that the mounting portion can be mounted on to supporting members of different depths;
(b) first and second bracing portions each extending from the mounting portion, the first bracing portion shaped to contact a first side of the supporting member and the second bracing portion shaped to contact an opposing second side of the supporting member, the first and second bracing portions thereby helping to brace the mounting portion on the supporting member; and
(c) a lantern retainer configured to retain the lantern and mounted to the mounting portion or one of the first and second bracing portions.

2. A lantern holder as claimed in claim 1 wherein the first and second bracing portions respectively extend adjacent to the first and second sides of the supporting member.

3. A lantern holder as claimed in claim 1 wherein the first and second adjustable pieces are slidable relative to each other.

4. A lantern holder as claimed in claim 3 wherein the second adjustable piece has a hollow interior shaped to receive the first adjustable piece therein.

5. A lantern holder as claimed in claim 4 wherein the first adjustable piece comprises a button movable between recessed and protruded positions on the first adjustable piece and the second adjustable piece comprises an aperture shaped and positioned to receive the button when it is in the protruded position and the first adjustable piece is in the hollow interior, the first adjustable piece being anchored to the second adjustable piece when the first adjustable piece is in the hollow interior and the button is in the aperture.

6. A lantern holder as claimed in claim 5 wherein the first adjustable piece further comprises a cavity and a spring disposed within the cavity that is movable between biased and unbiased positions, and wherein the button is coupled to one end of the spring and is in the recessed position when the spring is in the biased position and is in the protruded position when the spring is in the unbiased position.

7. A lantern holder as claimed in claim 5 wherein the button has a chamfered edge to facilitate insertion of the first adjustable piece into the hollow interior of the second adjustable piece.

8. A lantern holder as claimed in claim 1 wherein the first bracing portion comprises a lantern supporting portion extending therefrom such that the lantern supporting portion is not parallel to the first side of the supporting member, and wherein the lantern retainer is mounted on to the lantern supporting portion.

9. A lantern holder as claimed in claim 8 wherein the lantern supporting portion is perpendicular to the first side of the supporting member.

10. A lantern holder as claimed in claim 8 wherein the second bracing portion comprises an additional lantern supporting portion extending therefrom such that the additional lantern supporting portion is not parallel to the second side of the supporting member, and further comprising an additional lantern retainer mounted on to the additional lantern supporting portion.

11. A lantern holder as claimed in claim 10 wherein the additional lantern supporting portion is perpendicular to the second side of the supporting member.

12. A lantern holder for affixing a lantern to a rail or fence, the lantern holder comprising:
(a) a mounting portion shaped to mount to a top surface of the rail or fence and comprising first and second adjustable pieces slidable relative to each other such that the mounting portion can be mounted on to rails or fences of different depths;
(b) first and second bracing portions each extending downwards from the mounting portion, the first bracing portion shaped to contact a first side of the rail or fence and the second bracing portion extending adjacent to an opposing second side of the rail or fence, the first and second bracing portions thereby helping to brace the mounting portion on the rail or fence; and
(c) a lantern retainer configured to retain the lantern and mounted to a top surface of the mounting portion or one of the first and second bracing portions.

13. A lantern holder as claimed in claim 12 wherein the first and second bracing portions respectively extend adjacent to the first and second sides of the rail or fence.

14. A lantern holder as claimed in claim 12 wherein the second adjustable piece has a hollow interior shaped to receive the first adjustable piece therein.

15. A lantern holder as claimed in claim 14 wherein the first adjustable piece comprises a button movable between recessed and protruded positions on the first adjustable piece and the second adjustable piece comprises an aperture shaped and positioned to receive the button when it is in the protruded position and the first adjustable piece is in the hollow interior, the first adjustable piece being anchored to the second adjustable piece when the first adjustable piece is in the hollow interior and the button is in the aperture.

16. A lantern holder as claimed in claim 15 wherein the first adjustable piece further comprises a cavity and a spring disposed within the cavity that is movable between biased and unbiased positions, and wherein the button is coupled to one end of the spring and is in the recessed position when the spring is in the biased position and is in the protruded position when the spring is in the unbiased position.

17. A lantern holder as claimed in claim 15 wherein the button has a chamfered edge to facilitate insertion of the first adjustable piece into the hollow interior of the second adjustable piece.

18. A method for affixing a lantern to a rail or fence, the method comprising:
(a) sliding a lantern holder on to the rail or fence, the lantern holder comprising:
(i) a mounting portion shaped to mount to a top surface of the rail or fence;
(ii) first and second bracing portions each extending downwards from the mounting portion, the first bracing portion shaped to contact a first side of the rail or fence and the second bracing portion extending adjacent to an opposing second side of the rail or fence, the first and second bracing portions thereby helping to brace the mounting portion on the rail or fence; and
(iii) a lantern retainer configured to retain the lantern and mounted to a top surface of the mounting portion or one of the first and second bracing portions; and
(b) placing a lantern into the lantern retainer.

19. A method as claimed in claim 18 wherein the first and second bracing portions of the lantern holder respectively extend adjacent to the first and second sides of the rail or fence.

20. A method as claimed in claim 18 wherein the mounting portion comprises first and second adjustable pieces movable relative to each other such that the mounting portion can be mounted on to rails or fences of different depths.
